(19) United States
(12) Patent Application Publication
(10) Pub. No.: US 2003/0002469 A1
(43) Pub. Date: Jan. 2, 2003

(54) Method for allocation of resources in a telephone exchange system comprising a concentrating interface

(76) Inventors: Timo Juntunen, Oulu (FI); Olli Lonamaa, Oulu (FI); Tolvo Lallukka, Oulu (FI); Reuo Romppanen, Oulu (FI); Martti Yrjana, Tupos (FI); Pekka Lehto, Oulu (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/133,587

(22) Filed: Apr. 29, 2002

Related U.S. Application Data
(63) Continuation of application No. PCT/FI00/00931, filed on Oct. 26, 2000.

(30) Foreign Application Priority Data
Oct. 29, 1999 (FI) 1999234.1

(51) Int. Cl. H04L 12/66

(52) U.S. Cl. 370/338; 370/352; 370/347

(57) ABSTRACT

The invention relates to a method and system for the allocation of resources in a telephone exchange system, comprising a telephone exchange (LE), an access node (AN) and a concentrating interface (V5) by means of which the access node (AN) has been connected to the local exchange (LE). In the method, one or more separate subscriber groups are created in the local exchange (LE), and a predetermined share of time slots of the concentrating interface (V5) is allocated to the subscriber group.

In the method in accordance with the invention, it is possible to vary the priority per subscriber group.

### SCOPE OF THE INVENTION

The present invention relates to telecommunication systems. In particular, the invention relates to a new kind of method and system for the allocation of resources in a concentrating interface.

### PRIOR ART

Open interfaces (V5.1 and V5.2) between an access network and a local exchange are defined in the ETSI (European Telecommunications and Standard Institute) standards of the ETS 300 324 and ETS 300 347 series. V5 interfaces enable subscribers belonging to a physically separate access network to be connected to the local exchange using a standard interface. Dynamic concentrating interface V5.2 consistent with standards ETS 300 347-1 and 347-2 consists of one or more (1-16) PCM links (Pulse Code Modulation). One PCM link contains 32 channels or time slots, each with a transfer rate of 64 Kbytes/s, in other words, the total capacity of a PCM link is 2048 Kbytes/s. The V5.2 interface supports analogue telephones in a public telephone network, digital telephones, such as ISDN (Integrated Services Digital Network) basic and primary rate accesses or other analogue or digital terminal devices based on semi-permanent connections.

The maximum capacity of one V5.2 interface is about 500 B channels. This means that there may be about 500 calls going on simultaneously. Since the V5.2 interface is concentrating in its nature, the amount of the B channels is sufficient enough to serve about 5000 subscribers. The subscribers may be connected to the local exchange, e.g. via a specific access node. The access node is connected to the local exchange, e.g. via a V5 interface. The DAXnode 5000 manufactured by the applicant is one such access node.

The access node may comprise resources to be found out and dynamically allocated. The subscribers may be connected to the access node via a remote subscriber stage (RSS) thus enabling the concentration of subscribers to be connected to the access node by means of a modular cord between the remote subscriber stage and the access node. In addition, subscribers may be connected to the access node using the WLL, (Wireless Local Loop) thus enabling the concentration of subscribers in the interface between the access node and the radio network. Concentration in practice means that all the subscribers cannot be connected to the access node simultaneously, instead there is capacity sufficient only to a certain number of subscribers.

In addition to the actual signaling traffic, the definitions concerning the VS interface include separate O&M interfaces (O&M, Operation and Maintenance) for the local exchange and the access network. The management interface Q3 of the local exchange is defined by standards ETS 300 379-1 and ETS 300 377-1 of ETSI. The management interface means an interface between the local exchange and the telecommunications management network (TMN).

The V5 interface comprises two types of time slots: speech time slots, i.e. the B-channels, and time slots allocated to the signaling data, i.e. the C-channels. The V5.2 interface uses, in addition, standby channels to improve the protection of signaling channels. If one 2 Mbit/s bearer connection is used, then the system automatically allocates to the control protocol the time slot 16. Time slots 16, 15 and 31 may be allocated both to the public telephone network and the ISDN channels. If there are several bearer connections, the system automatically allocates to the control-, link control-, BCC-(Bearer Channel Connection) and protection protocols the time slot 16 of a primary link. Time slot 16 of a secondary link is also allocated to serve as a standby channel. The protection protocol of the V5 interface makes sure that the interface V5.2 containing many links operates, even in case of a PCM link failure. The protection protocol is used to protect all active C-channels. The protection protocol does not include speech channels. Time slots 1-31 may be allocated for the following purposes:

ISDN and PSTN (PSTN, Public Switched Telephone Network) B-channel,

Signaling channel including ISDN D-channel information, PSTN signaling or control data, or

Signaling channel including data pertaining to the control protocol of the V5 interface, link control protocol, protection protocol or the BCC protocol.

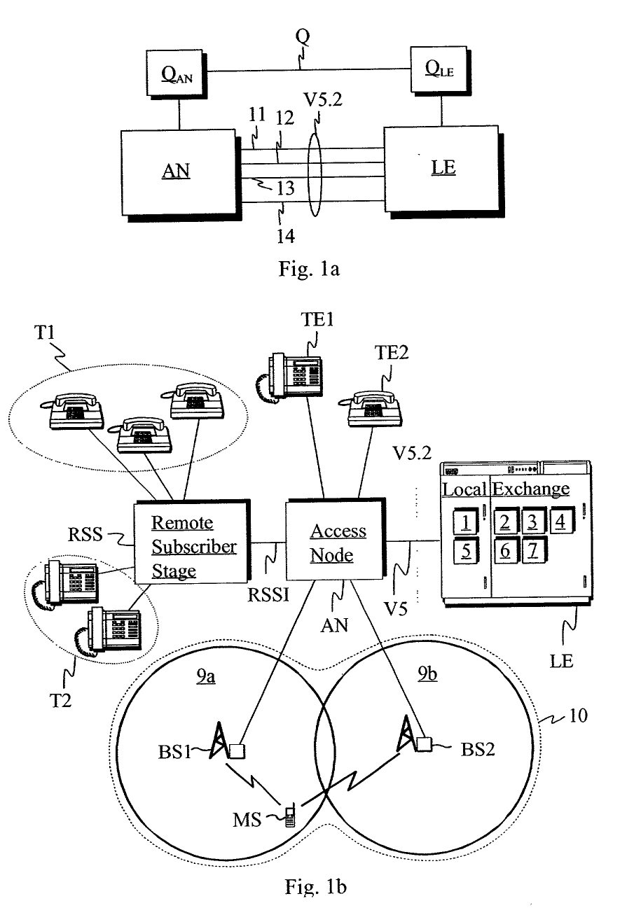

The V5.2 interface definitions comprise, among other things, the control- and PSTN protocols. The control protocol is responsible, e.g. for the creation of signaling channels in conjunction with the connection setup, control of the status of remote subscriber stages and co-operation with the protection protocol in a situation where the connection via a signaling channel is interrupted. The protection protocol protects the signaling channels, e.g. in a PCM link failure. The PSTN protocol is responsible, e.g. for transmitting status data concerning an access link to the access node, when it is a question about an analogue subscriber. In addition, the PSTN protocol is a link to the national PSTN definitions. The BCC protocol takes care of time slot allocation and deallocation in a concentrating interface. Protocols related to the V5 interface are described in greater detail in the standard series ETS 300 324 and ETS 300 347 of ETSI. FIG. 1a represents a system that comprises a V5.2 interface consistent with standards ETS 300 347. The system as presented in FIG. 1a comprises an access AN and a local exchange LE. In this example, the access node has been connected to the local exchange via a V5.2 interface comprising the links 11-14.

The access node AN is provided with a management interface Q_{AN}, and the local exchange LE is provided with a management interface Q_{LE}, thus enabling the controlling of the local exchange and the access node via the management interfaces Q_{LE} and Q_{AN}. The interfaces and structures of the management interfaces are defined in the standards. The local exchange and the access node are connected to the management interface Q via management interfaces Q_{LE} and Q_{AN}. The operator may, in accordance with the aforementioned standard, provide the interface also with permanent or semi-permanent time slots for specific subscribers.

If all the resources are in use, then it is a question of ensuring the successful transmission of extremely important calls, such as emergency calls. Resources are understood to mean, e.g. time slots in a concentrating interface to be allocated to subscribers. When setting up a call from the local exchange to the access node or vice versa, the local exchange selects the link of the V5.2 interface to be used and a suitable time slot in the link. The BCC protocol consistent with standard V5 notifies the access node of the data related to links and time slots, in order to be able to establish the call. In the case of an outgoing call, i.e. when setting up a call from the access node to the local exchange, the call may be left without the resource of the interface between the access node and the local exchange due to its overload, and the connection will fail.

THE OBJECTIVE OF THE INVENTION

The objective of the present invention is to eliminate the drawbacks presented above. One specific objective of the invention is to enable the allocation of resources in a new way in a V5.2 interface. This means, e.g. assignment of different priorities to different subscriber groups and, e.g. in this way it is possible to ensure the successful transmission of important calls. Due to the different priorities, one subscriber group may be allocated more capacity than another. Furthermore, the different priorities make it possible to influence the probability of a successful call.

In accordance with the above-mentioned, it is possible to generate unblocked subscriber groups. These groups may be guaranteed a successful call setup in any situation.

As for the features characteristic of the invention, reference is made to them in the claims.

### OBJECT OF THE INVENTION

The method in accordance with the invention relates to allocation of resources in a telephone exchange system. Advantageously the telecommunication system in accordance with the invention comprises a local exchange, an access node and a concentrating interface by means of which the access node is connected to the local exchange. Different types of subscribers may be connected to the local exchange by means of an access node. The local exchange is typically a DX 200 manufactured by the applicant.

In accordance with the invention, one or more separate subscriber groups are created in the local exchange. At the same time a predetermined share of time slots of the concentrating interface is allocated to the subscriber group. The subscriber group may also refer to a special service to which a certain share of time slots of the concentrating interface is allocated. The special service mentioned may refer, e.g. to emergency calls.

In other words, the B-channels of the concentrating V5.2 interface are shared between different subscriber groups, special services or other functions. A B-channel is used to mean a time slot that is reserved for the connection setup. A certain amount of B-channels are reserved for the use of a closed subscriber group or special service. The number of the time slots is subscriber-group-specific, in other words, different subscriber groups or special services may have different amounts of time slots assigned for use. On the relation between the subscribers and the time slots assigned depends what kind of priority a certain closed subscriber group enjoys. Therefore, it is possible to create a subscriber group with no priority at all or a group with a greater priority than the other subscribers of the interface.

The local exchange maintains information about the use of the time slots allocated to subscriber groups. The data is located, e.g. in the subscriber database. The aforementioned data is supposed to contain information, e.g. of how many time slots a subscriber group has been allocated to and how many time slots it at the moment has got available for use. The counter data is located either in separate files or in busing files. New entries are made by using user control commands, in which case the subscriber database and the separate counter files are updated. The main memory of the local exchange contains, in addition, information about the number of speech time slots included in a concentrating interface.

The resource data maintained in the subscriber database is real-time, i.e. it shows the actual situation going on each time in the V5.2 interface. When a subscriber of a subscriber group set ups a connection, then the number of time slots available for use of that subscriber group is reduced by the amount required by the connection. Correspondingly, the number of time slots available for use of that subscriber group is added by the amount of time slots released in conjunction with the call disconnection by a subscriber of the same subscriber group. The maximum limit for the number of time slots available for use is the amount of time slots beforehand allocated to the subscriber group.

In an advantageous embodiment of the invention, a subscriber group is created in the local exchange that is unblocked. This means that all the subscribers included in the subscriber group are entitled to set up a connection simultaneously. Furthermore, it is possible to create a subscriber group in the local exchange with the number of time slots assigned for use exceeding the number of subscribers. In this way, a specific subscriber group may be guaranteed non-blocking. Time slots allocated to subscriber groups are not fixed. In this way, any time slot may be handed for use for any subscriber group, when there is a need for a call setup. Furthermore, non-blocking may be ensured by using a circulating way of checking. This means that the time slots available for use are found out by checking the different PCM links of the bus in turn.

In an advantageous embodiment of the invention, an unblocked subscriber group is guaranteed its share of time slots even in case of a failure. A failure means, e.g. withdrawal of a PCM link, or that time slots are lost from the capacity for some other reason. In that case, the number of time slots assigned for use is going to be changed, if needed, except for the unblocked subscriber groups, in accordance with a predetermined principle. The program blocks monitoring the PCM links notify a specific resource manager of the corruption who will diminish the counter of time slots of subscribers in a concentrating interface in a certain predetermined manner, except for those included in the unblocked subscriber groups. The tasks of the resource manager include maintaining information of the total amount of speech time slots in a concentrating interface and maintaining information relating to the need of time slots required by different subscriber groups. Furthermore, the resource manager is responsible for updating the counters of speech time slots based on actual requests. Moreover, it is the resource manager who, based on the actual request received, will make the decision concerning the allocation of a vacant time slot to a call.

In an advantageous embodiment of the invention, a subscriber group referring to a subscriber is identified in conjunction with the connection setup. A successful call establishment depends on the fact of which subscriber group the subscriber belongs to and weather the subscriber group has vacant time slots assigned for use.

In the system of the present invention, one or more separate subscriber groups are created in the local exchange. In addition, the system comprises a first allocator by means of which a predetermined share of time slots of the concentrating interface is allocated to a subscriber group.

In an advantageous embodiment of the present invention, the system comprises a counter for maintaining data in the local exchange, which data comprises indication of the use of time slots allocated to a subscriber group.

In an advantageous embodiment of the present invention, the system comprises a second allocator for the allocation of time slots to the subscribers in a subscriber-group-specific way.

In an advantageous embodiment of the invention, the system comprises a maintainer for maintaining the share of time slots allocated to an unblocked subscriber group even in case of a failure, and a reducer for reducing the number of time slots allocated to other subscriber groups in case of a failure, if required.

In an advantageous embodiment of the present invention, the system comprises an identifier for the identification of a subscriber group referring to a specific subscriber in conjunction with the call setup.

In an advantageous embodiment of the present invention, the system comprises a subscriber database, wherein subscriber-specific information is maintained.

In an advantageous embodiment of the present invention, the concentrating interface is a V5.2 interface.

As compared with prior art, the present invention provides the advantage that due to the different priorities, different subscriber groups may be offered different kinds of service levels. At the same time, the priority relations may be used as a basis for pricing. Furthermore, the implementation in accordance with the invention does not set any specific requirements as to the functionality of the access node.

Thanks to the invention, in an emergency, congestion or other situations, in which it is crucial for the call to be set up, the availability of urgent numbers is guaranteed.

### LIST OF ILLUSTRATIONS

In the following section, the invention will be described in detail by way of examples of its embodiments, wherein

FIG. 1a represents a system that comprises a V5.2 interface consistent with the standard series ETS 300 347,

FIG. 1b represents one advantageous system in accordance with the invention, and

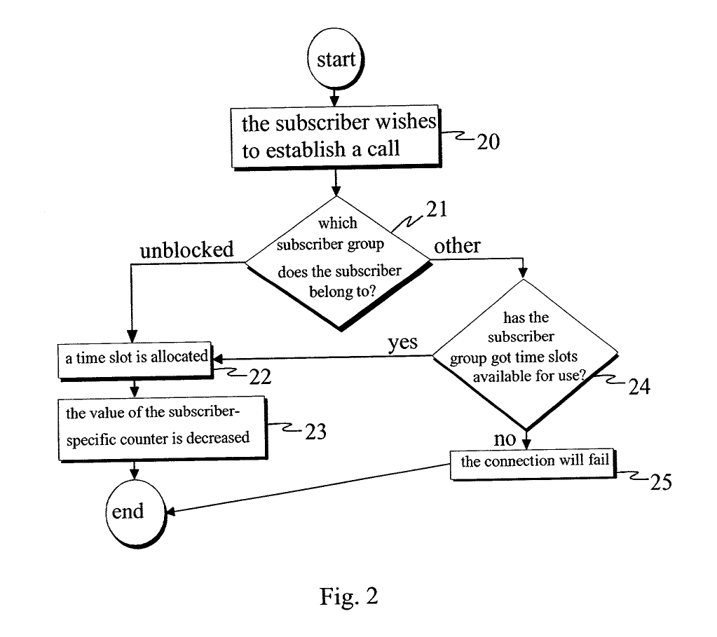

FIG. 2 represents, by way of example, one advantageous flow chart illustrating the function of the present invention.

### DETAILED DESCRIPTION OF THE INVENTION

FIG. 1b represents, by way of example, one system of implementing the invention. The system comprises a local exchange LE and an access node AN which is connected to the local exchange via a V5 interface. The interface between the local exchange LE and the access node AN is called the V5.2 interface. The functionality of the interface as well as the interface V5.2 are described in greater detail in the above-mentioned series ETS 300 347.

Subscribers may be connected to the local exchange LE and the access node AN in many different ways. FIG. 1b shows some of these modes by way of an example. The access node AN has got two terminal devices directly connected to it. In this example, terminal equipment TE1 stands for an analogue telephone, and terminal equipment TE2 for a digital ISDN telephone. Connected to the access node AN is also a wireless local loop WLL in which the terminal device MS is connected to the access node AN via a wireless local loop. The wireless local loop comprises at least one base station BS which is connected to the access node AN via an Abis interface. This example comprises two base stations BS1 and BS2 which form the cell areas 9a and 9b. The access node AN controls the operation of the base stations. Together the cell areas comprise a mobility area 10 which in this example is a restricted operation area bounding on the terminal equipment MS. The access node AN is connected to the local exchange LE via a V5 interface, in which case the terminal equipment MS of the WLL system is, from the point of view of the local exchange LE, a typical subscriber of a fixed network.

The system as presented in FIG. 1b comprises, in addition, a remote subscriber stage RSS which is connected to the access node AN via a concentrating connection RSSI. A concentrating connection is, e.g. a PCM link. As presented in FIG. 1b, two different subscriber groups, T1 and T2, have been connected to the remote subscriber stage RSS. Subscriber group T1 is comprised of PSTN subscribers (PSTN, Public Switched Telephone Network), and subscriber group T2 comprises of ISDN subscribers.

Even though not presented herein, it is obvious that a telephone network may be a remarkably bigger assembly than presented in FIG. 1b. Telephone exchange may comprise several telephone exchanges, access nodes and other network components.

In the system as presented in FIG. 1b, both the local exchange LE and the access node AN implement functions in accordance with the BCC protocol. The BCC protocol allocates the resources to be used in a call, such as time slots, and de-allocates them in a V5.2 interface. In practice, the BCC protocol manages the use of resources in a concentrating V5 interface.

In the subscriber database of the local exchange LE, one or more separate subscriber groups have been created. A subscriber group may also mean a special service to whose use a certain share of time slots of the concentrating interface is given. The aforementioned special service may concern, e.g. emergency calls. The subscriber database is located, e.g. in the main memory of the local exchange LE. Advantageously, one or more subscriber groups have been created by means of a program block, and specifically, e.g. by means of a user interface. A user interface refers to, e.g. a MML program (MML, Man Machine Language). MML means a command language that enables the managing, e.g. of telephone exchanges. The operator may, with the aid of the user interface, e.g. a computer, define the service level desired by his or her clients. Service level means in this context a certain level of priority. By means of the first allocator 1, a certain amount of time slots are allocated to a certain subscriber group. In this way, the operator may influence the priority of a certain subscriber group. The first allocator 1 is advantageously a program block, and specifically a user interface, and it is understood to mean, e.g. a MML program. The local exchange LE comprises a counter or counters 2 which are used to maintain in the local exchange LE information of the fact of how many time slots a subscriber group has been allocated to and how many time slots it at the moment has got available for use.

By means of a second allocator 3, time slots are allocated to a subscriber group in a subscriber-specific way in conjunction with the call setup. A second allocator 3 means advantageously a program block, and specifically a resource manager, or a BCC protocol object.

By means of a maintainer 4, the amount of time slots allocated to a certain unblocked subscriber group remains unchanged even in case of a failure, and the reducer 5 is used to reduce the amount of time slots available for other subscriber groups, if needed. The functions of the maintainer 4 and reducer 5 are tightly connected with the updating of the counter or counters 2. The maintainer 4 and reducer 5 are advantageously program blocks and may together form a bigger program block. This program block may also refer to the same program block as the second allocator 3.

By means of an identifier 6, a subscriber group referring to a subscriber is identified in conjunction with the call setup. The identifier 6 is advantageously a program block, and specifically, e.g. a program block taking care of the signalling in which the information is transmitted by means of a message interface. In addition, the local exchange LE comprises a subscriber database 7 for the storage of subscriber-group-specific information.

In an embodiment as presented in FIG. 1b, from the local exchange LE, a certain amount of logic B-channels are reserved to be used in predetermined situations. Predetermined situations may refer to, e.g. different situations related to an overload and emergency calls. These logic B-channels reserved for certain predetermined situations are not used for normal phone calls. The time slots are used only in a case when all the other normal B-channels are in use. In other words, if there are speech time slots meant for normal use available for use, then e.g. also emergency calls may use speech time slots meant for regular phone calls.

The logic B-channels are not separated from the bus of the B-channels meant for normal use to serve as a separate bus, instead all the speech time slots at a V5.2 interface are on the same bus. For the managing of the logic B-channels reserved, e.g. for emergency calls, a counter-type feature is used. In this way, the availability and usability of the logic B-channels always remains, also in a case of a PCM link or bus failure or interruptions. The logic B-channels are not bounded by certain PCM links of the interface nor by certain time slots. Time slot allocation is carried out according to a normal principle of finding out the resources. The counters used help to handle the situation so that even in an overload case there are enough time slots to allocate.

The counters are separately fixed for the amount of speech time slots of the entire interface, the amount of speech time slots reserved for normal use, and the amount of speech time slots allocated to emergency traffic in an overload case. Each counter is updated according to the load of the traffic. The counter contains, e.g. information of the amount of time slots available for use and the amount of time slots taken by the calls.

The following table shows a configuration with 120 speech time slots included in it. For the emergency traffic of an overload case there are three time slots allocated.

| Counter | Value | Example |
|---|---|---|
| Vacant speech time slots of the | x | 120 |
| entire interface (configurated | | |
| initial value x) | | |
| Vacant speech time slots meant | y | 3 |
| for the emergency traffic of | | |
| an overload case (configurated | | |
| initial value y) | | |
| Vacant speech time slots re- | x − y | 117 |
| served for normal use (initial | | |
| value x − y) | | |

Should the total amount of speech time slots at a V5.2 interface due to a PCM link failure decrease, the amount of time slots allocated to emergency calls would still remain the same. In that case, only the amount of speech time slots in normal use is reduced. This means also that the priority concerning regular calls is increased.

The following table presents a failure situation in which 30 speech time slots are lost from the capacity.

| Counter | Value | Example |
|---|---|---|
| Vacant speech time slots of | x − 30 | 90 |
| the entire interface | | |
| Vacant speech time slots | y | 3 |
| meant for the emergency | | |
| traffic of an overload case. | | |
| Vacant speech time slots re- | x − y − 30 | 87 |
| served for normal use | | |

When there are enough B-channels reserved for normal use, all calls may use them—including, e.g. emergency calls.

The following table presents a call which may be, e.g. an emergency call or a regular call.

| Counter | Value | Example |
|---|---|---|
| Vacant speech time slots of | x − 1 | 119 |
| the entire interface | | |
| Vacant speech time slots | y | 3 |
| meant for the emergency | | |
| traffic of an overload case. | | |
| Vacant speech time slots re- | x − y − 1 | 116 |
| served for normal use | | |

When the amount of traffic is increasing and the B-channels reserved for normal use are running out, each new call is allocated a logic B-channel normally reserved for emergency use. If the subscriber dials an emergency number, then it possible to proceed with the call setup. In that case, the call is using a logic B-channel reserved, e.g. for emergency use.

The following table presents an example of an overload case. In this situation, all the speech time slots reserved for normal use are in use.

| Counter | Value | Example |
|---|---|---|
| Vacant speech time slots of | x − 117 | 3 |
| the entire interface | | |
| Vacant speech time slots | y | 3 |
| meant for the emergency | | |
| traffic of an overload case. | | |
| Vacant speech time slots re- | x − y − 117 | 0 |
| served for normal use | | |

When all the speech time slots reserved for normal use are taken, ending phone calls is allowed only to the subscriber stations that are in emergency use. One this station is, e.g. a subscriber station of the Local Alarm Centre. The local exchange LE performs a digit analysis as a consequence of which the line cannot be reserved, if it is a question about a normal call. The following example shows the establishing of a new outgoing call.

| Counter | Value | Example |
|---|---|---|
| Vacant speech time slots of | X − 117 − 1 | 2 |
| the entire interface | | |
| Vacant speech time slots | y − 1 | 2 |
| meant for the emergency | | |
| traffic of an overload case. | | |
| Vacant speech time slots re- | X − y − 117 | 0 |
| served for normal use | | |

The subscriber dials the numbers, and the local exchange LE performs the digit analysis. If it is not a question about an emergency call, then the local exchange gives a busy tone. The subscriber on-hooks, and the line is freed. The following table presents this variant.

| Counter | Value | Example |
|---|---|---|
| Vacant speech time slots of | x − 117 | 3 |
| the entire interface | | |
| Vacant speech time slots | Y | 3 |
| meant for the emergency | | |
| traffic of an overload case. | | |
| Vacant speech time slots re- | x − y − 117 | 0 |
| served for normal use | | |

If it is a question about an emergency call, then the call setup is continued. The following table presents this variant.

| Counter | Value | Example |
|---|---|---|
| Vacant speech time slots of | x − 117 − 1 | 2 |
| the entire interface | | |
| Vacant speech time slots | y − 1 | 2 |
| meant for the emergency | | |
| traffic of an overload case. | | |
| Vacant speech time slots re- | x − y − 117 | 0 |
| served for normal use | | |

If during a specific phone call, normal B-channels become free, then an emergency call as shown by the above example may be directed to a B-channel normally reserved for regular calls. The parameters of the local exchange help to define whether the call is forwarded or not. No physical switching is needed for the forwarding. It is enough to update the relevant counters. This means, e.g. that the value of the counter associated with normal speech time slots is increased, whereas the value of the counter of so-called logic B-channels reserved for emergency use is decreased. This procedure guarantees that there are enough logic B-channels to be allocated to new calls.

The following table shows an example, where a B-channel reserved for a regular call becomes free, but the emergency call is not directed to a B-channel reserved for regular calls.

| Counter | Value | Example |
|---|---|---|
| Vacant speech time slots of | x − 116 − 1 | 3 |
| the entire interface | | |
| Vacant speech time slots | y − 1 | 2 |
| meant for the emergency | | |
| traffic of an overload case. | | |
| Vacant speech time slots re- | x − y − 116 | 1 |
| served for normal use | | |

The following table shows an example, where a B-channel reserved for a regular call becomes free, and the emergency call is directed to a B-channel reserved for regular calls.

| Counter | Value | Example |
|---|---|---|
| Vacant speech time slots of | x − 117 | 3 |
| the entire interface | | |
| Vacant speech time slots | y | 3 |
| meant for the emergency | | |
| traffic of an overload case. | | |
| Vacant speech time slots re- | x − y − 117 | 0 |
| served for normal use | | |

FIG. 2 represents one example of the function of the present invention by way of a flow chart. As shown by block 20, a subscriber belonging to a subscriber group wishes to establish a call. The local exchange receives the call request and makes judgements as to which subscriber group the subscriber does belong to, block 21. If the subscriber group has been defined as unblocked, proceeding into block 22 is followed. In block 22, the local exchange allocates to the subscriber some vacant time slot. The call setup of an unblocked subscriber is always successful, if only the V5 interface is in operation and the number of unblocked subscribers does not exceed the capacity of the V5 interface. In addition, the local exchange is at any time informed of the amount of time slots still left for use by a subscriber group. As shown by block 23, the value of this counter is decreased.

If the subscriber does not belong to an unblocked subscriber group, then block 24 is entered. Some other subscriber refers herein to all other subscribers, except unblocked subscriber groups. In block 24, it is checked whether a subscriber group has got vacant time slots available for use. Altogether, the number of vacant time slots per a subscriber group depends on priority. If there are a lot of subscribers included in a subscriber group and correspondingly only few time slots to allocate, the probability of congestion is bigger than if there were more time slots to allocate. If a subscriber group has got time slots still available for use, then block 22 is entered, and from it as presented above, block 23 is entered.

When entering block 25 the subscriber group has no vacant time slots available for use, and due to this, the call setup is not successful.

The invention is not restricted to the examples of its embodiments, instead many variations are possible within the scope of the invention defined by the claims.

1. A method for the allocation of resources in a telephone exchange system, comprising:
a local exchange (LE),
an access node (AN),
a concentrating interface (V5) by means of which the access node (AN) has been connected to the local exchange (LE),
characterised in that the system comprises the following steps:
one or more separate subscriber groups are created in the local exchange (LE); and
a predetermined share of time slots of the concentrating interface (V5) is allocated to a subscriber group.

2. A method as defined in claim 1, characterised in that the local exchange (LE) maintains information of the use of time slots allocated to a subscriber group.

3. A method as defined in claim 1 or 2, characterised in that time slots are allocated to a subscriber group in a subscriber-specific way.

4. A method as defined in any one of the preceding claims 1-3, characterised in that in the local exchange (LE), a subscriber group is created which is unblocked, or the priority of which is significantly smaller than the one of the other subscriber groups.

5. A method as defined in any one of the preceding claims 1-4, characterised in that in the local exchange (LE), a subscriber group is created whose share of time slots exceeds the number of subscribers.

6. A method as defined in any one of the preceding claims 1-5, characterised in that in case of a failure,
the number of time slots allocated to an unblocked subscriber group is kept unchanged; and
if required, the number of time slots allocated to other subscriber groups is reduced.

7. A method as defined in any one of the preceding claims 1-6, characterised in that a subscriber group referring to a subscriber is identified in conjunction with the call setup.

8. A method as defined in any one of the preceding claims 1-7, characterised in that subscriber-specific information is maintained in the subscriber database.

9. A method as defined in any one of the preceding claims 1-8, characterised in that the concentrating interface (V5) is a V5.2 interface.

10. A method for the allocation of resources in a telephone exchange system, comprising:
a local exchange (LE),
an access node (AN),
a concentrating interface (VS) by means of which the access node (AN) has been connected the local exchange (LE),
characterised in that in the system:
in the local exchange (LE), one or more separate subscriber groups are created; and that the system comprises:
a first allocator (1) by means of which a predetermined share of time slots of the concentrating interface (V5) is allocated to a subscriber group.

11. A system as defined in claim 10, characterised in that the system comprises a counter (2) for maintaining information in the local excange (LE), which information comprises indication of the use of time slots allocated to a subscriber group.

12. A system as defined in claim 10 or 11, characterised in that the system comprises a second allocator (3) for the allocation of time slots of a subscriber group in a subscriber-specific way.

13. A system as defined in any one of the preceding claims 10-12, characterised in that system comprises:
a maintainer (4) for maintaining the number of time slots allocated to an unblocked subscriber in case of a failure; and
a reducer (5) for reducing, if required, the number of time slots available for other subscriber groups in case of a failure.

14. A system as defined in any one of the preceding claims 10-13, characterised in that system comprises an identifier (6) for identifying a subscriber group referring to a subscriber in conjunction with the call setup.

15. A system as defined in any one of the preceding claims 10-14, characterised in that system comprises a subscriber database (7) in which subscriber-specific information is maintained.

16. A system as defined in any one of the preceding claims 10-15, characterised in that the concentrating interface (V5) is a V5.2 interface.
